(19) United States
(12) Patent Application Publication
(10) Pub. No.: US 2026/0025185 A1
(43) Pub. Date: Jan. 22, 2026

(54) DATA COLLECTION METHOD AND APPARATUS FOR AI-BASED CSI PREDICTION

(71) Applicant: VIVO MOBILE COMMUNICATION CO., LTD., Dongguan (CN)

(72) Inventors: Bule SUN, Dongguan (CN); Jianming WU, Dongguan (CN); Jialin LI, Dongguan (CN)

(21) Appl. No.: 19/344,485

(22) Filed: Sep. 29, 2025

Related U.S. Application Data
(63) Continuation of application No. PCT/CN2024/085790, filed on Apr. 3, 2024.

(30) Foreign Application Priority Data
Apr. 7, 2023 (CN) 202310370594.4

(51) Int. Cl. H04B 7/06; H04L 41/16

(52) U.S. Cl. CPC H04B 7/0626; H04L 41/16

(57) ABSTRACT

This application discloses a data collection method and apparatus for AI-based CSI prediction, and belongs to the field of communication technologies. The method in embodiments of this application includes any one of the following: autonomously performing, by a terminal, CSI data collection to obtain CSI data; or performing, by a terminal, CSI data collection based on first information, to obtain CSI data, where the CSI data is used for AI model training of AI-based CSI prediction; where the first information includes at least one of the following: AI model identifier information, used to indicate an AI model corresponding to the CSI data; applicable condition information, used to indicate a condition or a scenario for data collection; data collection start condition information; data collection continuity condition information; data collection termination condition information; or data collection-related CSI-RS configuration information, used to indicate CSI-RS configuration information of data collection for AI-based CSI prediction.

### CROSS-REFERENCE TO RELATED APPLICATIONS

This application is a continuation of International Patent Application No. PCT/CN2024/085790, filed on Apr. 3, 2024, which claims priority to Chinese Patent Application No. 202310370594.4, entitled “DATA COLLECTION METHOD AND APPARATUS FOR AI-BASED CSI PREDICTION”, filed on Apr. 7, 2023, both of which are incorporated herein by reference in their entireties.

### TECHNICAL FIELD

This application belongs to the field of communication technologies, and specifically relates to a data collection method and apparatus for AI-based CSI prediction.

### BACKGROUND

Artificial intelligence (Artificial Intelligence, AI) is currently widely used in various fields. In AI-based channel state information (Channel State Information, CSI) prediction, data collection is mainly related to AI model training and AI model monitoring. Data collection for these two purposes has different formats and requirements.

### SUMMARY

Embodiments of this application provide a data collection method and apparatus for AI-based CSI prediction.

According to a first aspect, a data collection method for AI-based CSI prediction is provided, where the method is performed by a terminal, and the method includes any one of the following:
autonomously performing, by a terminal, CSI data collection to obtain CSI data; or
performing, by a terminal, CSI data collection based on first information, to obtain CSI data, where the CSI data is used for AI model training of AI-based CSI prediction;
where the first information includes at least one of the following:
AI model identifier information, used to indicate an AI model corresponding to the CSI data;
applicable condition information, used to indicate a condition or a scenario for data collection;
data collection start condition information, used to indicate a start condition of data collection;
data collection continuity condition information, used to indicate a continuity condition of data collection;
data collection termination condition information, used to indicate a termination condition of data collection; or
data collection-related channel state information reference signal CSI-RS configuration information, used to indicate CSI-RS configuration information of data collection for AI-based CSI prediction.

According to a second aspect, a data collection method for AI-based CSI prediction is provided, where the method is performed by a network side device, and the method includes any one of the following:
sending, by a network side device, first information to a terminal;
receiving, by a network side device, first information from a terminal, and sending an acknowledgment indication to the terminal, where the acknowledgment indication is used to indicate the terminal to perform CSI data collection based on the first information to obtain CSI data, and the CSI data is used for AI model training of AI-based CSI prediction; or
receiving, by a network side device, first information from a terminal, where the first information is used to indicate that a data collection operation that meets the first information has been completed or request to report CSI data that meets the first information;
where the first information includes at least one of the following:
AI model identifier information, used to indicate an AI model corresponding to the CSI data;
applicable condition information, used to indicate a condition or a scenario for data collection;
data collection start condition information, used to indicate a start condition of data collection;
data collection continuity condition information, used to indicate a continuity condition of data collection;
data collection termination condition information, used to indicate a termination condition of data collection; or
data collection-related channel state information reference signal CSI-RS configuration information, used to indicate CSI-RS configuration information of data collection for AI-based CSI prediction.

According to a third aspect, a data collection apparatus for AI-based CSI prediction is provided, where the apparatus is applied to a terminal, and the apparatus includes:
a collection module, configured to perform at least one of the following:
autonomously performing CSI data collection to obtain CSI data; or
performing CSI data collection based on first information, to obtain CSI data, where the CSI data is used for AI model training of AI-based CSI prediction;
where the first information includes at least one of the following:
AI model identifier information, used to indicate an AI model corresponding to the CSI data;
applicable condition information, used to indicate a condition or a scenario for data collection;
data collection start condition information, used to indicate a start condition of data collection;
data collection continuity condition information, used to indicate a continuity condition of data collection;
data collection termination condition information, used to indicate a termination condition of data collection; or
data collection-related channel state information reference signal CSI-RS configuration information, used to indicate CSI-RS configuration information of data collection for AI-based CSI prediction.

According to a fourth aspect, a data collection apparatus for AI-based CSI prediction is provided, where the apparatus is applied to a network side device, and the apparatus includes:
a first communication module, configured to perform any one of the following:
sending first information to a terminal;
receiving first information from a terminal, and sending an acknowledgment indication to the terminal, where the acknowledgment indication is used to indicate the terminal to perform CSI data collection based on the first information to obtain CSI data, and the CSI data is used for AI model training of AI-based CSI prediction; or
receiving first information from a terminal, where the first information is used to indicate that a data collection operation that meets the first information has been completed or request to report CSI data that meets the first information;
where the first information includes at least one of the following:
AI model identifier information, used to indicate an AI model corresponding to the CSI data;
applicable condition information, used to indicate a condition or a scenario for data collection;
data collection start condition information, used to indicate a start condition of data collection;
data collection continuity condition information, used to indicate a continuity condition of data collection;
data collection termination condition information, used to indicate a termination condition of data collection; or
data collection-related channel state information reference signal CSI-RS configuration information, used to indicate CSI-RS configuration information of data collection for AI-based CSI prediction.

According to a fifth aspect, a terminal is provided. The terminal includes a processor and a memory. The memory stores a program or instructions capable of running on the processor, and the program or the instructions are executed by the processor to implement the steps of the method according to the first aspect.

According to a sixth aspect, a terminal is provided, including a processor and a communication interface, where the processor is configured to perform at least one of the following:
autonomously performing CSI data collection to obtain CSI data; or
performing CSI data collection based on first information, to obtain CSI data, where the CSI data is used for AI model training of AI-based CSI prediction;
where the first information includes at least one of the following:
AI model identifier information, used to indicate an AI model corresponding to the CSI data;
applicable condition information, used to indicate a condition or a scenario for data collection;
data collection start condition information, used to indicate a start condition of data collection;
data collection continuity condition information, used to indicate a continuity condition of data collection;
data collection termination condition information, used to indicate a termination condition of data collection; or
data collection-related channel state information reference signal CSI-RS configuration information, used to indicate CSI-RS configuration information of data collection for AI-based CSI prediction.

According to a seventh aspect, a network side device is provided. The network side device includes a processor and a memory. The memory stores a program or instructions capable of running on the processor, and the program or the instructions are executed by the processor to implement the steps of the method according to the second aspect.

According to an eighth aspect, a network side device is provided, including a processor and a communication interface, where the communication interface is configured to perform any one of the following:
sending first information to a terminal;
receiving first information from a terminal, and sending an acknowledgment indication to the terminal, where the acknowledgment indication is used to indicate the terminal to perform CSI data collection based on the first information to obtain CSI data, and the CSI data is used for AI model training of AI-based CSI prediction; or
receiving first information from a terminal, where the first information is used to indicate that a data collection operation that meets the first information has been completed or request to report CSI data that meets the first information;
where the first information includes at least one of the following:
AI model identifier information, used to indicate an AI model corresponding to the CSI data;
applicable condition information, used to indicate a condition or a scenario for data collection;
data collection start condition information, used to indicate a start condition of data collection;
data collection continuity condition information, used to indicate a continuity condition of data collection;
data collection termination condition information, used to indicate a termination condition of data collection; or
data collection-related channel state information reference signal CSI-RS configuration information, used to indicate CSI-RS configuration information of data collection for AI-based CSI prediction.

According to a ninth aspect, a readable storage medium is provided. The readable storage medium stores a program or instructions, and when the program or the instructions are executed by a processor, the steps of the method according to the first aspect are implemented, or the steps of the method according to the second aspect are implemented.

According to a tenth aspect, a wireless communication system is provided, including a terminal and a network side device, where the terminal may be configured to perform the steps of the method according to the first aspect, and the network side device may be configured to perform the steps of the method according to the second aspect.

According to an eleventh aspect, a chip is provided. The chip includes a processor and a communication interface. The communication interface is coupled to the processor, and the processor is configured to run a program or instructions to implement the method according to the first aspect, or to implement the method according to the second aspect.

According to a twelfth aspect, a computer program/program product is provided, where the computer program/program product is stored in a storage medium, and the program/program product is executed by at least one processor to implement the steps of the data collection method for AI-based CSI prediction according to the first aspect, or to implement the steps of the data collection method for AI-based CSI prediction according to the second aspect.

### BRIEF DESCRIPTION OF DRAWINGS

FIG. 1 is a schematic diagram of a wireless communication system applicable to an embodiment of this application;

FIG. 2 is a schematic diagram of a structure of a neural network according to an embodiment of this application;

FIG. 3 is a schematic diagram of calculation logic of a neuron according to an embodiment of this application;

FIG. 4 is a schematic diagram of AI-based CSI prediction according to an embodiment of this application;

FIG. 5 is a schematic diagram of system performance corresponding to prediction of CSI at different future moments by using an AI model according to an embodiment of this application;

FIG. 6 is a first schematic flowchart of a data collection method for AI-based CSI prediction according to an embodiment of this application;

FIG. 7 is a second schematic flowchart of a data collection method for AI-based CSI prediction according to an embodiment of this application;

FIG. 8 is a first signaling interaction diagram of a data collection method for AI-based CSI prediction according to an embodiment of this application;

FIG. 9 is a second signaling interaction diagram of a data collection method for AI-based CSI prediction according to an embodiment of this application;

FIG. 10 is a third signaling interaction diagram of a data collection method for AI-based CSI prediction according to an embodiment of this application;

FIG. 11 is a fourth signaling interaction diagram of a data collection method for AI-based CSI prediction according to an embodiment of this application;

FIG. 12 is a fifth signaling interaction diagram of a data collection method for AI-based CSI prediction according to an embodiment of this application;

FIG. 13 is a sixth signaling interaction diagram of a data collection method for AI-based CSI prediction according to an embodiment of this application;

FIG. 14 is a seventh signaling interaction diagram of a data collection method for AI-based CSI prediction according to an embodiment of this application;

FIG. 15 is a first schematic diagram of a structure of a data collection apparatus for AI-based CSI prediction according to an embodiment of this application;

FIG. 16 is a second schematic diagram of a structure of a data collection apparatus for AI-based CSI prediction according to an embodiment of this application;

FIG. 17 is a communication device according to an embodiment of this application;

FIG. 18 is a schematic diagram of a hardware structure of a terminal according to an embodiment of this application; and

FIG. 19 is a network side device according to an embodiment of this application.

### DESCRIPTION OF EMBODIMENTS

The following clearly describes technical solutions in embodiments of this application with reference to accompanying drawings in embodiments of this application. Clearly, the described embodiments are merely some rather than all of embodiments of this application. All other embodiments obtained by a person of ordinary skill in the art based on embodiments of this application shall fall within the protection scope of this application.

The terms “first”, “second”, and the like in this application are used to distinguish between similar objects instead of describing a specified order or sequence. It should be understood that, terms used in this way are interchangeable under appropriate circumstances, so that embodiments of this application can be implemented in a sequence other than that illustrated or described herein. Moreover, the terms “first” and “second” typically distinguish between objects of one category rather than limiting a quantity of objects. For example, there may be one or more first objects. In addition, “or” in this application represents at least one of connected objects. For example, “A or B” includes three solutions, that is, solution 1: including A and not including B; solution 2: including B and not including A; and solution 3: including both A and B. The character “/” generally represents an “or” relationship between associated objects.

The term “indication” in this application may be either a direct indication (or an explicit indication) or an indirect indication (or an implicit indication). The direct indication may be understood as: A sender explicitly notifies, in a sent indication, a receiver of specific information, an operation that needs to be performed, a requested result, or other content. The indirect indication may be understood as: The receiver determines corresponding information based on the indication sent by the sender, or performs determining based on the indication sent by the sender, and determines, based on a determining result, the operation that needs to be performed or the requested result.

It should be noted that, a technology described in embodiments of this application is not limited to a long term evolution (Long Term Evolution, LTE)/LTE-advanced (LTE-Advanced, LTE-A) system, and may be further applied to other wireless communication systems, such as a code division multiple access (Code Division Multiple Access, CDMA) system, a time division multiple access (Time Division Multiple Access, TDMA) system, a frequency division multiple access (Frequency Division Multiple Access, FDMA) system, an orthogonal frequency division multiple access (Orthogonal Frequency Division Multiple Access, OFDMA) system, a single-carrier frequency-division multiple access (Single-carrier Frequency-Division Multiple Access, SC-FDMA) system, or another system. The terms “system” and “network” are often used interchangeably in embodiments of this application. The technology described may be used for the systems and radio technologies described above, as well as other systems and radio technologies. The following describes a new radio (New Radio, NR) system for illustrative purposes, and NR terms are used in most of the following descriptions. However, these technologies are also applicable to systems such as a 6th generation (6th Generation, 6G) communication system other than the NR system.

Currently, for data collection of AI model training, a channel state information reference signal (Channel State Information Reference Signal, CSI-RS) configuration of an existing 5th generation mobile communication technology (5th Generation Mobile Communication Technology, 5G) is directly used, and data collection for AI-based CSI prediction cannot be supported.

Embodiments of this application provide a data collection method and apparatus for AI-based CSI prediction, which can solve a problem that an existing CSI-RS configuration cannot support data collection for AI-based CSI prediction.

In embodiments of this application, compared with that an existing CSI-RS configuration cannot support data collection for AI-based CSI prediction, in embodiments of this application, a terminal can perform CSI data collection autonomously or based on first information to obtain CSI data, and further may perform AI model training of AI-based CSI prediction by using the CSI data. That is, the data collection method for AI-based CSI prediction provided in this application can support data collection for AI-based CSI prediction.

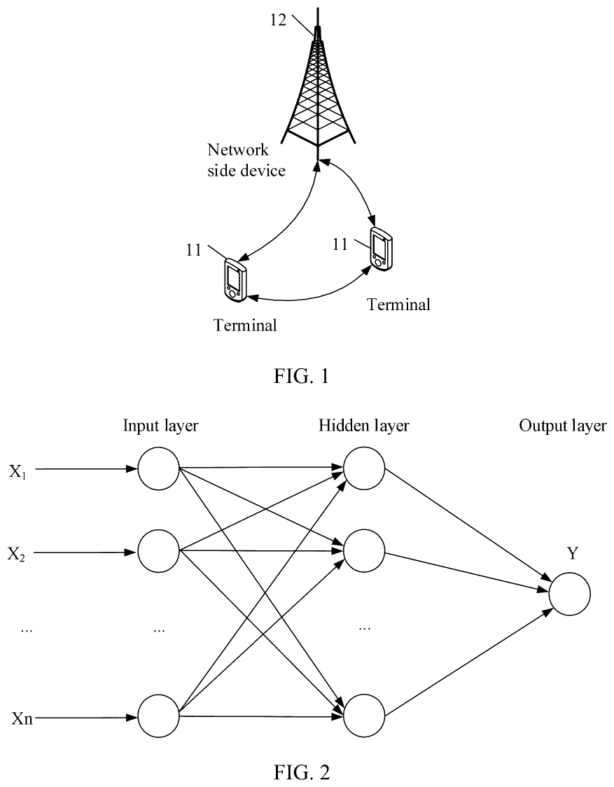

FIG. 1 is a schematic diagram of a wireless communication system applicable to an embodiment of this application. FIG. 1 is a block diagram of a wireless communication system applicable to an embodiment of this application. The wireless communication system includes a terminal 11 and a network side device 12. The terminal 11 may be a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile internet device (Mobile Internet Device, MID), an augmented reality (Augmented Reality, AR) device, a virtual reality (Virtual Reality, VR) device, a robot, a wearable device (Wearable Device), a flight vehicle (flight vehicle), vehicle user equipment (Vehicle User Equipment, VUE), ship-mounted equipment, pedestrian user equipment (Pedestrian User Equipment, PUE), a smart home (a home device with a wireless communication function, for example, a refrigerator, a television, a laundry machine, or a furniture), a gaming console, a personal computer (Personal Computer, PC), a teller machine, a self-service machine, or another terminal-side device. The wearable device includes: a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in embodiments of this application. The network side device 12 may include an access network device or a core network device. The access network device may also be referred to as a radio access network (Radio Access Network, RAN) device, a radio access network function, or a radio access network unit. The access network device may include a base station, a wireless local area network (Wireless Local Area Network, WLAN) access point (Access Point, AS), a wireless fidelity (Wireless Fidelity, WiFi) node, or the like. The base station may be referred to as a NodeB (NodeB, NB), an evolved NodeB (Evolved NodeB, eNB), the next generation NodeB (the next generation NodeB, gNB), a new radio NodeB (New Radio NodeB, NR NodeB), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home NodeB, HNB), a home evolved NodeB (home evolved NodeB), a transmission reception point (Transmission Reception Point, TRP), or another proper term in the field. The base station is not limited to a specific technical term, provided that the same technical effect is achieved. It should be noted that in embodiments of this application, only a base station in an NR system is used as an example for description, and a specific type of the base station is not limited.

The core network device may include but is not limited to at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function (Policy and Charging Rules Function, PCRF) unit, an edge application server discovery function (Edge Application Server Discovery Function, EASDF), unified data management (Unified Data Management, UDM), a unified data repository (Unified Data Repository, UDR), a home subscriber server (Home Subscriber Server, HSS), a centralized network configuration (Centralized network configuration, CNC), a network repository function (Network Repository Function, NRF), a network exposure function (Network Exposure Function, NEF), a local NEF (Local NEF or L-NEF), a binding support function (Binding Support Function, BSF), an application function (Application Function, AF), and the like. It should be noted that in embodiments of this application, only a core network device in an NR system is used as an example for description, and a specific type of the core network device is not limited.

To facilitate a clearer understanding of the technical solutions provided in embodiments of this application, the following first describes some related background knowledge.

AI is currently widely used in various fields. An AI module has a plurality of implementations, such as a neural network, a decision tree, a support vector machine, and a Bayesian classifier. In this application, the neural network is used as an example for description, but a specific type of the AI module is not limited.

FIG. 2 is a schematic diagram of a structure of a neural network according to an embodiment of this application. As shown in FIG. 2, a neural network includes an input layer, a hidden layer, and an output layer. X₁, X₂, and Xₙ are input to the neural network, and Y is output of the neural network.

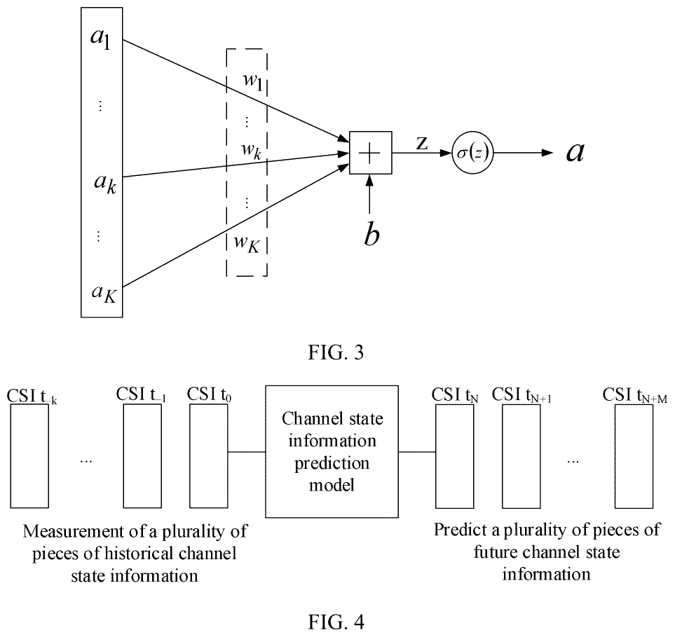

The neural network includes a neuron. FIG. 3 is a schematic diagram of calculation logic of a neuron according to an embodiment of this application. As shown in FIG. 3, a₁, aₖ, and a_{K} are input, w₁, wₖ, and w_{K} are weights (multiplicative coefficient), b is an offset (additive coefficient), and σ(z) is an activation function. Common activation functions include Sigmoid, tanh, a linear rectification function (also referred to as rectified linear unit (Rectified Linear Unit, ReLU)), and the like; and z may be represented by using the following formula (1):

$$z = {a}_{1} {w}_{1} + … + {a}_{k} {w}_{k} + … + {a}_{K} {w}_{K} + b ; \qquad ( 1 )$$

A parameter of the neural network is optimized by using a gradient optimization algorithm. The gradient optimization algorithm is an algorithm for minimizing or maximizing an objective function (sometimes also referred to as a loss function), and the objective function is often a mathematical combination of a model parameter and data.

For example, given data X and a corresponding label Y, a neural network model f(.) is constructed. After the model is available, prediction output f(x) may be obtained according to the input X, and a difference (f(x)−Y) between a prediction value and a real value may be calculated. This is a loss function. A purpose is to find appropriate w and b so that a value of the loss function is minimized. The smaller the loss value, the closer the model is to a real situation.

Currently, a common optimization algorithm is basically based on an error back propagation (error Back Propagation, BP) algorithm. A basic idea of the BP algorithm is that a learning process includes forward propagation of a signal and error back propagation. During forward propagation, an input sample is passed in from the input layer and is transferred to the output layer after being processed layer by layer by hidden layers. If actual output of the output layer does not match expected output, the error back propagation phase is entered. Error back propagation is to back propagate an output error layer by layer by using the hidden layers to the input layer in a specific form, and allocate the error to all units of each layer, so as to obtain an error signal of each layer of units. This error signal is used as a basis for correcting a weight of each unit. A weight adjustment process of each layer of signal forward propagation and error back propagation is performed repeatedly. A process of continuously adjusting a weight is a network learning and training process. This process proceeds until the output error of the network is reduced to an acceptable level or until a preset quantity of learning times is performed.

Generally, a selected AI algorithm and an adopted AI model are different according to different solution types. A main way to improve 5G network performance with AI is to enhance or replace an existing algorithm or processing module by using a neural network-based algorithm and an AI model. In a specific scenario, the neural network-based algorithm and AI model can achieve better performance than a deterministic-based algorithm. A common neural network includes a deep neural network, a convolutional neural network, a recurrent neural network, and the like. With an existing AI tool, a neural network can be built, trained, and verified.

Replacing a module in an existing system with an AI or machine learning (Machine Learning, ML) method can effectively improve system performance.

FIG. 4 is a schematic diagram of AI-based CSI prediction according to an embodiment of this application. As shown in FIG. 4, historical CSI, that is, CSI t₀, CSI t₋₁, . . . , and CSI t₋ₖ are input to a CSI prediction model. An AI model analyzes a time domain change characteristic of a channel, and outputs future CSI, that is, CSI t_{N}, CSI t_{N+1}, . . . , and CSI t_{N+M}.

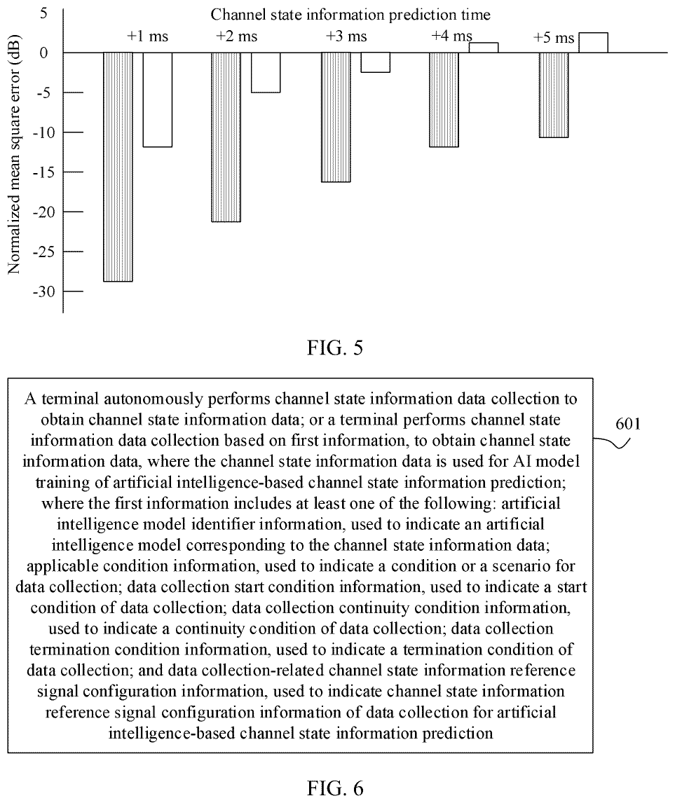

FIG. 5 is a schematic diagram of system performance corresponding to prediction of CSI at different future moments by using an AI model according to an embodiment of this application. As shown in FIG. 5, a horizontal axis represents time for predicting future CSI; a vertical axis represents a normalized mean square error (Normalized mean square error, NMSE), used to represent system performance; a histogram filled with vertical lines indicates that the AI model predicts an NMSE corresponding to further 1-step CSI; and a white histogram indicates that there is no AI model to predict an NMSE corresponding to future CSI.

As can be seen from FIG. 5, AI-based CSI prediction can have a very large performance gain compared to a non-prediction solution. In addition, as predicted future moments vary, achievable prediction accuracy will also differ.

Currently, the 3rd Generation Partnership Project (3rd Generation Partnership Project, 3GPP) is discussing AI-based CSI prediction, and no conclusion has been reached on how to support AI-based CSI prediction. Data collection for AI-based CSI prediction cannot be supported by directly using a CSI-RS configuration of existing 5G. For this reason, this application proposes a data collection method for AI-based CSI prediction, which is used to support data collection for AI-based CSI prediction and collected data reporting.

With reference to the accompanying drawings, the following describes in detail, by using some embodiments and application scenarios thereof, a data collection method and apparatus for AI-based CSI prediction provided in embodiments of this application.

The data collection method for AI-based CSI prediction provided in embodiments of this application may be applied to a communication system with a wireless AI function such as 5.5G or 6G, and may be specifically applied to a terminal, so that the terminal performs data collection to obtain CSI data used for AI-based CSI prediction to perform AI model training.

FIG. 6 is a first schematic flowchart of a data collection method for AI-based CSI prediction according to an embodiment of this application. As shown in FIG. 6, the method includes step 601.

Step 601: A terminal autonomously performs CSI data collection to obtain CSI data; or the terminal performs CSI data collection based on first information, to obtain CSI data, where the CSI data is used for AI model training of AI-based CSI prediction; where the first information includes at least one of the following: AI model identifier information, used to indicate an AI model corresponding to the CSI data; applicable condition information, used to indicate a condition or a scenario for data collection; data collection start condition information, used to indicate a start condition of data collection; data collection continuity condition information, used to indicate a continuity condition of data collection; data collection termination condition information, used to indicate a termination condition of data collection; or data collection-related CSI-RS configuration information, used to indicate CSI-RS configuration information of data collection for AI-based CSI prediction.

In AI-based CSI prediction in related technologies, data collection is mainly related to AI model training and AI model monitoring. Data collection for these two purposes has different formats and requirements.

For AI model training, data used for AI model training does not have a high delay requirement, but a data amount is large. In terms of format, data required for AI model training needs to include both historical CSI and CSI of to-be-predicted time (future CSI).

For AI model monitoring, data used for AI model monitoring has a high delay requirement and needs to be collected or transmitted in time, and a data amount is generally small. In terms of format, data required for model monitoring includes only CSI of to-be-predicted time (future CSI).

This embodiment of this application mainly discusses content related to data collection required for AI model training.

During CSI prediction, a plurality of pieces of historical CSI are used to predict one or more pieces of future CSI. The historical CSI may generally be at an equal interval, or may be at any interval, and a prediction time location may be at any future time point.

During prediction of CSI at a future time point:
(1) If a prediction time location is consistent with a period of a CSI-RS (that is, periodic prediction), data collection can be completed by using a periodic CSI-RS configuration in an existing 5G standard; and
(2) If the prediction time location is inconsistent with the period of the CSI-RS (that is, aperiodic prediction), a new CSI-RS configuration needs to be designed or configurations need to be combined to complete data collection.

This embodiment of this application may be divided into the following two cases:
Case 1: The terminal may autonomously perform CSI data collection to obtain CSI data, and determine first information based on the CSI data. Optionally, the first information herein may be used to represent a configuration corresponding to the CSI data; and
Case 2: The terminal may perform CSI data collection based on first information to obtain CSI data, so as to perform AI model training of AI-based CSI prediction by using the CSI data.

It should be noted that the first information may be configured by a network side device, or may be determined autonomously by the terminal.

Optionally, after performing CSI data collection to obtain the CSI data, the terminal may actively report data to the network side device; or may first send a data reporting request to the network side device, so that the network side device indicates whether data reporting is supported.

The first information includes at least one of the following:
1) AI model identifier information, used to indicate an AI model corresponding to the CSI data.

Specifically, the AI model identifier information is used to determine to which AI model the collected CSI data is corresponding.

Optionally, the AI model identifier information may include at least one of the following:
a. an AI function identifier (IDentity, ID);
specifically, the AI function ID may also be referred to as a functionality ID;
b. an AI model ID;
specifically, the AI model ID may also be referred to as a model ID;
c. an AI model physical ID;
d. an AI model logical ID;
e. an AI model global ID; and
f. an AI model local ID.

It should be noted that the AI model in this embodiment of this application may also be referred to as an AI unit, an AI structure, or the like, or the AI model may be a processing unit that can implement a specific algorithm, formula, processing procedure, capability, or the like related to AI, or the AI model may be a processing method, algorithm, function, module, or unit that is for a specific data set, or the AI model may be a processing method, algorithm, function, module, or unit that runs on AI-related hardware such as a graphic processing unit (Graphic Processing Unit, GPU), a neural-network processing Unit (Neural-network Processing Unit, NPU), a tensor processing unit (tensor processing unit, TPU), an application specific integrated circuit (Application Specific Integrated Circuit, ASIC), or the like. This is not specifically limited in this application.

Optionally, the AI model identifier information may include an AI model ID, an AI structure ID, or an AI algorithm ID, or an ID of a specific data set associated with the AI model, or an AI-related specific scenario, environment, channel feature, or device ID, or an AI-related function, characteristic, capability, or module ID. This is not specifically limited in this application.

Optionally, the AI may alternatively be represented as an ML, and there are a plurality of implementations, such as a neural network, a decision tree, a support vector machine, and a Bayesian classifier. This is not specifically limited in this application.
2) applicable condition information, used to indicate a condition or a scenario for data collection.

Specifically, the applicable condition information is used to indicate a condition or a scenario in which current data is collected, and an AI model trained based on the data is also bound to the applicable condition. The applicable condition may be assistance information (assistance information), which is bound to data collection and AI model identifier information.

Optionally, the applicable condition information may include at least one of the following:
a. a channel condition;
specifically, the channel condition includes, for example, a signal to noise ratio (Signal to Noise Ratio, SNR), a signal to interference plus noise ratio (Signal to Interference plus Noise Ratio, SINR), and RSRP.
b. a scenario condition;
specifically, the scenario condition includes, for example, indoors and outdoors;
c. a moving speed condition; or
d. an accessed cell range or cell ID list (list) condition.

Specifically, the cell range is, for example, a distance range, representing a cell within a distance of 5 km from a specified location.

It should be noted that the applicable condition information may be used as condition information for determining starting and ending of data collection, or may be used as a basis for determining whether collected data is available or unavailable, whether collected data is to be retained or not, whether collected data is to be reported or not.
3) data collection start condition information, used to indicate a start condition of data

collection.

Optionally, the data collection start condition information may include at least one of the following:
a. data collection start time;
b. a data collection start location;
specifically, the data collection start location may be limited by a real location, or may be limited by using an accessed cell ID; or
c. applicable condition information.

Specifically, data collection may be started only in a case that the applicable condition information is met.
4) data collection continuity condition information, used to indicate a continuity condition of data collection.

Optionally, the data collection continuity condition information may include at least one of the following:
a. a condition of a quantity of collected CSI or samples;
specifically, the condition of the quantity of collected CSI or samples is, for example, continuous collection is performed in a case that the quantity of collected CSI or samples does not reach a given threshold;
b. a collection duration condition;
specifically, the collection duration condition is, for example, continuous collection is performed in a case that collection time does not reach a given threshold; or
c. applicable condition information.

Specifically, continuous collection may be performed in a case that the applicable condition information is met.

It should be noted that the data collection continuity condition information may further include at least one of the following:
d. a channel condition;
specifically, continuous collection may be performed in a case that a given channel condition is met;
e. a speed condition;
specifically, continuous collection may be performed in a case that a given speed condition is met; or
f. a location range condition.

Specifically, continuous collection may be performed in a case of being within a given location range. The location range may be limited by a real location, or may be limited by an accessed cell ID.
5) data collection termination condition information, used to indicate a termination condition of data collection.

Optionally, the data collection termination condition information may include at least one of the following:
a. end time;
b. collection time exceeds a first threshold;
c. a quantity of collected CSI or CSI samples exceeds a second threshold;
d. meeting or not meeting applicable condition information;
specifically, data collection may be terminated in a case that the applicable condition information is met or not met, for example, a channel condition (for example, an SNR, an SINR, or RSRP) exceeds or is lower than a given threshold or a speed exceeds a threshold; or
e. a quantity of cell handover times exceeds a third threshold.
6) data collection-related channel state information reference signal (Channel State Information Reference Signal, CSI-RS) configuration information, used to indicate CSI-RS configuration information of data collection for AI-based CSI prediction.

Optionally, the data collection-related CSI-RS configuration information may include at least one of the following:
a. CSI-RS configuration information used for collecting at least one piece of historical CSI and at least one piece of to-be-predicted/future CSI;
specifically, the to-be-predicted/future CSI corresponds to a prediction time location;
b. CSI-RS configuration information used for collecting at least one piece of historical CSI and at least one piece of to-be-predicted/future CSI, and period information;
in an embodiment, the data collection-related CSI-RS configuration information may include: CSI-RS configuration information+period information used to collect at least one piece of historical CSI and at least one piece of to-be-predicted/future CSI, so as to perform data collection semi-continuously or periodically;
c. CSI-RS configuration information used for channel measurement, and CSI-RS configuration information used for collecting at least one piece of to-be-predicted/future CSI; or
d. CSI-RS configuration information used for channel measurement and a first data collection characteristic, where the first data collection characteristic is used to indicate the terminal to retain or store CSI data measured based on the CSI-RS configuration information used for channel measurement.

Specifically, the CSI-RS configuration information used for channel measurement, that is, a conventional periodic CSI-RS configuration information, is used to collect the CSI-RS configuration information of at least one piece of historical CSI.

In the data collection method for AI-based CSI prediction provided in this embodiment of this application, compared with that an existing CSI-RS configuration cannot support data collection for AI-based CSI prediction, in embodiments of this application, a terminal can perform CSI data collection autonomously or based on first information to obtain CSI data, and further may perform AI model training of AI-based CSI prediction by using the CSI data. That is, the data collection method for AI-based CSI prediction provided in this application can support data collection for AI-based CSI prediction.

Optionally, the terminal may receive reporting information from a network side device, where the reporting information is used to indicate CSI report configuration information of data collection for AI-based CSI prediction.

It should be noted that the network side device may simultaneously send the reporting information and the first information to the terminal, or may separately send the reporting information and the first information to the terminal.

Optionally, the reporting information may include at least one of the following:
a. a reporting granularity, including CSI or a CSI prediction sample;
optionally, the CSI prediction sample may include at least one of the following:
A1. at least one piece of historical CSI; and
A2. at least one piece of to-be-predicted/future CSI.
b. a time sequence indication, used to indicate whether CSI data is continuously reported;
c. an annotation indication, used to indicate whether a type of CSI data is annotated, where the type of the CSI data includes historical CSI or to-be-predicted/future CSI;
d. CSI report configuration information used for channel feedback; or
e. a second data collection characteristic, used to indicate the terminal to retain or store CSI data fed back based on the CSI report configuration information used for channel feedback.

Specifically, if it is indicated that CSI is used as a basic granularity for reporting, the network side device generates, from the CSI data, a CSI prediction sample used for CSI prediction. In this case, if data is data required for periodic CSI prediction, the data needs to be continuously reported, and a time sequence of CSI needs to be ensured. In case of aperiodic CSI prediction, it is necessary to mark whether reported CSI is historical CSI or to-be-predicted/future CSI.

If it is indicated that a sample required for CSI prediction is used as a basic granularity for reporting, the terminal generates, from the CSI data, a CSI prediction sample used for CSI prediction. One sample includes historical CSI and to-be-predicted/future CSI. In this case, no special time sequence requirement or annotation requirement is required for reporting.

It should be noted that, the data collection-related CSI-RS configuration information and the reporting information are newly defined dedicated CSI-RS configuration information and CSI report configuration information compared with a CSI-RS used for channel measurement and CSI report configuration information used for channel feedback in an existing protocol.

The data collection-related CSI-RS configuration information and the reporting information in this embodiment of this application are added with a data collection characteristic based on the CSI-RS configuration information or the CSI report configuration information of the existing protocol. The data collection characteristic may be configured by using a supplementary field.

After receiving the CSI-RS configuration information or the reporting information, a data collection device needs to retain or store CSI data if the data collection characteristic is marked. If the data collection characteristic is not marked, this group of CSI data is not retained after channel feedback is completed according to existing CSI-RS configuration information or CSI report configuration information.

The following uses an example to describe a relationship between CSI and a CSI prediction sample.

I. For periodic CSI prediction, historical CSI and to-be-predicted/future CSI may be obtained from time-continuous CSI data in a sliding window manner, to generate a plurality of CSI prediction samples. The to-be-predicted/future CSI is used as a label for AI model training, and the to-be-predicted/future CSI includes at least one piece of CSI.

For example, collected time-continuous CSI data is collected in slots such as [0, 5, 10, 15, 20, 25, 30, 35, 40, 45, 50, . . . ] (a time domain interval is 5 slots), and the following periodic CSI prediction samples may be generated by using this group of time-continuous CSI data.
Sample 1: The historical CSI is CSI in slots [0, 5, 10, 15, 20], and the to-be-predicted/future CSI is CSI in slots [25, 30].
Sample 2: The historical CSI is CSI in slots [5, 10, 15, 20, and 25], and the to-be-predicted/future CSI is CSI in slots [30, 35].
Sample 3: The historical CSI is CSI in slots [10, 15, 20, 25, 30], and the to-be-predicted/future CSI is CSI in slots [35, 40].
Sample 4: The historical CSI is CSI in slots [15, 20, 25, 30, 35], and the to-be-predicted/future CSI is CSI in slots [40, 45].

By analogy, sample N: The historical CSI is CSI in slots [5(N−1), 5N, 5(N+1), 5(N+2), (N+3)], and the to-be-predicted/future CSI is CSI in slots [5(N+4), 5(N+5)].
II. For aperiodic CSI prediction, a specific CSI-RS configuration or a combination of a plurality of CSI-RS configurations is required to generate a sample.
(1) Specific CSI-RS configuration (not supported in an existing protocol, and a new CSI-RS configuration needs to be defined, that is, a dedicated data collection CSI-RS for CSI prediction).

For example, a CSI-RS time domain configuration required for collecting the historical CSI and the to-be-predicted/future CSI is written into one piece of CSI-RS configuration information.
\textcircled{1} A new CSI-RS configuration is triggered each time to collect a CSI prediction sample, that is, an aperiodic CSI-RS manner. \textcircled{2} Semi-continuous or periodic collection is performed by using basic CSI-RS configuration information+period information.
Sample 1: The historical CSI is CSI in slots [0, 5, 10, 15, 20, 25], and the to-be-predicted/future CSI is CSI in slot [28].
Sample 2: The historical CSI is CSI in slots [30, 35, 40, 45, 50, 55], and the to-be-predicted/future CSI is CSI in slot [58].
Sample 3: The historical CSI is CSI in slots [60, 65, 70, 75, 80, 85], and the to-be-predicted/future CSI is CSI in slot [88].

The solution \textcircled{1} may be used to trigger a new CSI-RS configuration each time to perform collection. Alternatively, the solution \textcircled{2} with a basic CSI-RS configuration of slots [0, 5, 10, 15, 20, 25, 28]+a period of 30 slots is used for implementation.
(2) Combination of a plurality of CSI-RS configurations: The historical CSI and the to-be-predicted/future CSI are collected by using two different CSI-RS configurations.

For example, the historical CSI may be obtained by using a conventional periodic CSI-RS. For example, CSI in slots such as [0, 5, 10, 15, 20, 25, 30, 35, 40, 45, 50, . . . ] (a time domain interval is 5 slots) is collected by using a CSI-RS configuration whose start location is slot 0 and whose period is 5 slots. The to-be-predicted/future CSI needs to be obtained by using another CSI-RS configuration. For example, CSI in slots such as [28, 33, 38, . . . ] is collected by using a CSI-RS configuration whose start location is slot 28 and whose period is 5 slots.

In this way, an aperiodic CSI prediction sample may be generated based on two groups of CSI, for example, [0, 5, 10, 15, 20, 25] are used for prediction of [28], [5, 10, 15, 20, 25, 30] are used for prediction of [33], and [10, 15, 20, 25, 30, 35] are used for prediction of [38].

For another example, CSI in slots such as [28, 58, 88, . . . ] is collected as the to-be-predicted/future CSI by using a CSI-RS configuration whose start location is slot 28 and whose period is 30 slots.

In this way, an aperiodic CSI prediction sample may be generated based on two groups of CSI, for example, [0, 5, 10, 15, 20, 25] are used for prediction of [28], [30, 35, 40, 45, 50, 55] are used for prediction of [58], [60, 65, 70, 75, 80, 85] are used for prediction of [88].

Optionally, the data collection method for AI-based CSI prediction provided in this application may be specifically divided into the following solutions:
Solution 1: The terminal directly receives the first information from the network side device, and performs CSI data collection based on the first information.

Specifically, the first information may be configured by a network side. The terminal receives the first information from the network side device, and performs CSI data collection based on the first information to obtain the CSI data.

Optionally, an implementation in which the terminal receives the first information from the network side device may include:
The terminal may receive the first information transmitted by the network side device based on at least one of the following information or signaling:
(1) a medium access control (Medium Access Control, MAC) control element (Control Element, CE);
(2) a radio resource control (Radio Resource Control, RRC) message;
(3) a non-access stratum (Non-Access Stratum, NAS) message;
(4) a management and orchestration message;
(5) user plane data;
(6) downlink control information (Downlink Control Information, DCI) information;
(7) a system information block (System Information Block, SIB);
(8) layer 1 signaling of a physical downlink control channel (Physical Downlink Control Channel, PDCCH); 23

(9) information about a physical downlink shared channel (Physical Downlink Shared Channel, PDSCH);
(10) message (MSG) 2 information of a physical random access channel (Physical Random Access Channel, PRACH);
(11) MSG 4 information of the PRACH; or
(12) MSG B information of the PRACH.

Solution 2: The terminal sends the first information to the network side device, so as to request the network side device to perform CSI data collection based on the first information, and after receiving an acknowledgement indication from the network side device, the terminal performs CSI data collection based on the first information.

Specifically, before the terminal performs CSI data collection based on the first information to obtain the CSI data, the terminal may send the first information to the network side device.

The terminal receives an acknowledgment indication from the network side device, where the acknowledgment indication is used to indicate the terminal to perform CSI data collection based on the first information.

Specifically, the terminal may first send the first information to the network side device, so that the network side device determines whether CSI data collection may be performed based on the first information. In a case that the terminal receives an acknowledgment indication from the network side device, it represents that the terminal may perform CSI data collection based on the first information. In this case, the terminal performs CSI data collection based on the first information.
Solution 3: The terminal sends second information to the network side device, so that the network side device corrects the second information to obtain the first information, and perform CSI data collection based on the first information.

Before the terminal performs CSI data collection based on the first information, to obtain the CSI data, the terminal sends the second information to a network side device, where the second information includes information related when the terminal performs data collection or data reporting for AI-based CSI prediction; and
the terminal receives the first information from the network side device, where the first information is related to the second information.

Specifically, the terminal may first send the second information to the network side device, where the second information includes information related when the terminal performs data collection or data reporting for AI-based CSI prediction. The network side device may determine the first information based on the second information, and send the first information to the terminal, so as to indicate the terminal to perform CSI data collection based on the first information. After receiving the first information, the terminal may perform CSI data collection based on the first information.

Optionally, based on the foregoing solutions 1 to 3, for data reporting, the terminal may send a data reporting request to the network side device. The data reporting request is used to represent that the terminal has collected the CSI data;
the terminal receives a data reporting instruction from the network side device; and
the terminal sends the CSI data or a CSI prediction sample corresponding to the CSI data to the network side device based on the data reporting instruction and the reporting information.

Specifically, the terminal may send the data reporting request to the network side device after collecting the CSI data, so as to represent that the terminal has collected the CSI data and requests to report the data to the network side device.

In a case of determining, based on the data reporting request, that a reporting requirement is met, the network side device may send a data reporting instruction to the terminal, and the terminal may report the data to the network side device based on the data reporting instruction and the reporting information. Specifically, the terminal may send the CSI data or the CSI prediction sample corresponding to the CSI data to the network side device.
Solution 4: After the terminal autonomously performs CSI data collection, to obtain the CSI data, the terminal determines the first information based on the CSI data, and sends the first information to the network side device, where the first information is used to indicate that a data collection operation that meets the first information has been completed or request to report CSI data that meets the first information;
the terminal receives a data reporting instruction from the network side device; and
the terminal sends the CSI data or a CSI prediction sample corresponding to the CSI data to the network side device based on the data reporting instruction and the reporting information.

Specifically, after autonomously performing CSI data collection, the terminal may determine the first information based on the CSI data, and then send the first information to the network side device, which may be specifically divided into the following two cases:
1) The terminal sends the first information to the network side device, so as to indicate that the terminal has completed a data collection operation that meets the first information.
2) The terminal sends the first information to the network side device, so as to indicate that the terminal has collected CSI data based on the first information, and requests to report CSI data that meets the first information to the network side device.

After receiving the first information, the network side device may send a data reporting instruction to the terminal in a case of determining, based on the first information, that the collected CSI data meets a reporting requirement. The terminal may report the data to the network side device based on the data reporting instruction and the reporting information. Specifically, the terminal may send the CSI data or the CSI prediction sample corresponding to the CSI data to the network side device.

In an embodiment, the terminal may alternatively directly send the first information to the network side device, so as to indicate that the terminal has completed a data collection operation that meets the first information, or request to report CSI data that meets the first information to the network side device.

It should be noted that the first information may be sent by the terminal to the network side device before data collection is performed, so as to request to perform data collection that meets the first information, or may be sent by the terminal to the network side device after data collection is completed based on the first information, so as to report, to the network side device, that the terminal has completed data collection that meets the first information, or requests to report data that meets the first information.

If the first information is sent by the terminal to the network side device before data collection, after receiving the foregoing request or recommendation, the network side device sends acknowledgement information or delivers configuration information related to data collection to the terminal, and then the terminal collects and reports data for CSI prediction according to the first information sent by the network side device.

If the first information is sent by the terminal to the network side device after data collection, the network side device may send a data reporting instruction to the terminal.

Optionally, in a case that abnormal CSI exists in the CSI data, performing, by the terminal, any one of the following processing on the abnormal CSI:
(1) discarding the abnormal CSI, and reporting an indication corresponding to the abnormal CSI;
(2) reporting the abnormal CSI based on a preset format; and
(3) constructing, based on continuous CSI and the abnormal CSI that are in the CSI data, target CSI corresponding to the abnormal CSI, and reporting the target CSI.

Specifically, if the collected CSI data is discontinuous in a time sequence (for example, when data collection is performed, a specific piece of CSI is omitted, or a hardware detection miss occurs); or if the collected CSI is invalid (for example, an SINR suddenly deteriorates or experiences a severe fading channel), one piece of CSI or some pieces of CSI are abnormal, and special processing needs to be performed. The special processing may include:
(1) discarding this piece of or those pieces of abnormal CSI, and reporting an indication corresponding to the abnormal CSI;
(2) reporting this piece of or those pieces of abnormal CSI in a special format, where this special format is agreed upon in advance by a receive end and a transmit end; and
(3) after performing some preprocessing on the abnormal CSI, the terminal reports preprocessed CSI, for example, constructs or forges, based on previous continuous CSI and currently collected abnormal CSI, CSI that meets a continuity requirement, and reports the CSI.

The data collection method for AI-based CSI prediction provided in this embodiment of this application may be applied to a network side device.

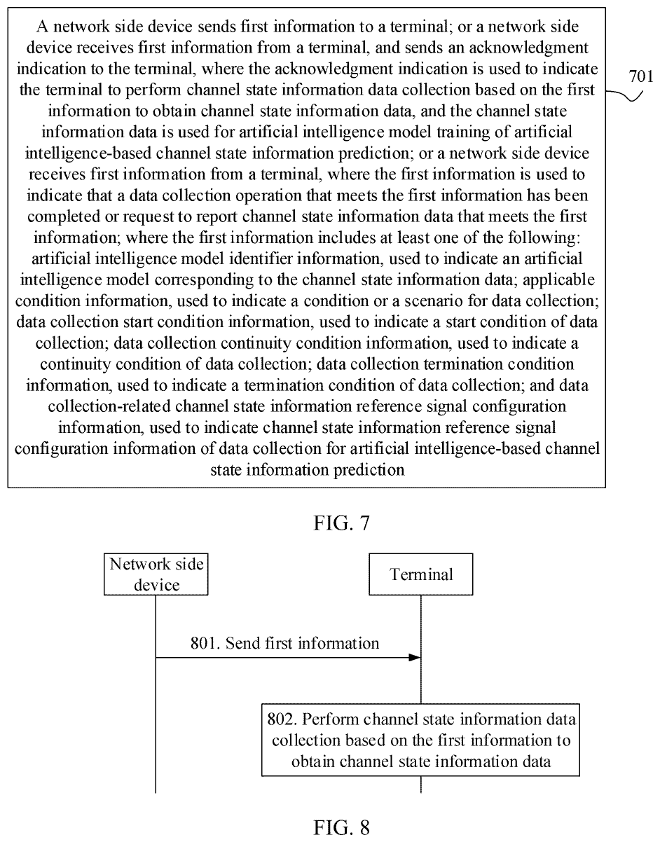

FIG. 7 is a second schematic flowchart of a data collection method for AI-based CSI prediction according to an embodiment of this application. As shown in FIG. 7, the method includes step 701.

Step 701: A network side device sends first information to a terminal; or a network side device receives first information from a terminal, and sends an acknowledgment indication to the terminal, where the acknowledgment indication is used to indicate the terminal to perform CSI data collection based on the first information to obtain CSI data, and the CSI data is used for AI model training of AI-based CSI prediction; or a network side device receives first information from a terminal, where the first information is used to indicate that a data collection operation that meets the first information has been completed or request to report CSI data that meets the first information; where the first information includes at least one of the following: AI model identifier information, used to indicate an AI model corresponding to the CSI data; applicable condition information, used to indicate a condition or a scenario for data collection; data collection start condition information, used to indicate a start condition of data collection; data collection continuity condition information, used to indicate a continuity condition of data collection; data collection termination condition information, used to indicate a termination condition of data collection; or data collection-related CSI-RS configuration information, used to indicate CSI-RS configuration information of data collection for AI-based CSI prediction.

This embodiment of this application may be divided into the following three cases:
(1) The network side device sends the first information to the terminal, so that the terminal performs CSI data collection based on the first information to obtain the CSI data.

Specifically, that the network side device sends the first information to the terminal may be divided into the following two sub-cases:
Case 1: The network side device directly sends the first information to the terminal; and
Case 2: The network side device receives second information from the terminal, determines the first information based on the second information, and sends the first information to the terminal, where the second information includes information related when the terminal performs data collection or data reporting for AI-based CSI prediction.
(2) The network side device first receives the first information from the terminal, and sends an acknowledgment indication to the terminal, so as to indicate the terminal to perform CSI data collection based on the first information to obtain the CSI data.
(3) The network side device receives the first information from the terminal, where the first information is used to indicate that a data collection operation that meets the first information has been completed or request to report CSI data that meets the first information.

Specifically, that the network side device receives the first information from the terminal may be divided into the following two sub-cases:
Case 1: After autonomously performing CSI data collection to obtain the CSI data, the terminal may determine the first information based on the CSI data, and send the first information to the network side device, so as to report, to the network side device, that the terminal has completed a data collection operation that meets the first information; and
Case 2: After autonomously performing CSI data collection to obtain the CSI data, the terminal may determine the first information based on the CSI data, and send the first information to the network side device, so as to request to report CSI data that meets the first information to the network side device.

In the data collection method for AI-based CSI prediction provided in this embodiment of this application, compared with that an existing CSI-RS configuration cannot support data collection for AI-based CSI prediction, in this embodiment of this application, a network side device may send first information to a terminal; or a network side device sends an acknowledgment indication to a terminal by receiving first information from the terminal, so as to indicate the terminal to perform CSI data collection based on the first information; or a network side device receives first information from a terminal, so as to indicate that a data collection operation that meets the first information has been completed or request to report CSI data that meets the first information, and further may perform AI model training of AI-based CSI prediction by using the CSI data. That is, the data collection method for AI-based CSI prediction provided in this application can support data collection for AI-based CSI prediction.

Optionally, the AI model identifier information may include at least one of the following:
1) an AI function ID;
2) an AI model ID;
3) an AI model physical ID;
4) an AI model logical ID;
5) an AI model global ID; or
6) an AI model local ID.

Optionally, the applicable condition information may include at least one of the following:
(1) a channel condition;
(2) a scenario condition;
(3) a moving speed condition; or
(4) an accessed cell range or cell ID list condition.

Optionally, the data collection start condition information may include at least one of the following:
1) data collection start time;
2) a data collection start location; or
3) applicable condition information.

Optionally, the data collection continuity condition information may include at least one of the following:
(1) a condition of a quantity of collected CSI or samples;
(2) a collection duration condition; or
(3) applicable condition information.

Optionally, the data collection termination condition information may include at least one of the following:
1) end time;
2) collection time exceeds a first threshold;
3) a quantity of collected CSI or CSI samples exceeds a second threshold;
4) meeting or not meeting applicable condition information; or
5) a quantity of cell handover times exceeds a third threshold.

Optionally, the data collection-related CSI-RS configuration information may include at least one of the following:
(1) CSI-RS configuration information used for collecting at least one piece of historical CSI and at least one piece of to-be-predicted/future CSI;
(2) CSI-RS configuration information used for collecting at least one piece of historical CSI and at least one piece of to-be-predicted/future CSI, and period information;
(3) CSI-RS configuration information used for channel measurement, and CSI-RS configuration information used for collecting at least one piece of to-be-predicted/future CSI; or
(4) CSI-RS configuration information used for channel measurement and a first data collection characteristic, where the first data collection characteristic is used to indicate the terminal to retain or store CSI data measured based on the CSI-RS configuration information used for channel measurement.

Optionally, an implementation in which the network side device sends the first information to the terminal may include:
The network side device may transmit the first information to the terminal based on at least one of the following information or signaling:
(1) a MAC CE;
(2) an RRC message;
(3) a NAS message;
(4) a management and orchestration message;
(5) user plane data;
(6) DCI information;
(7) a SIB;
(8) layer 1 signaling of a PDCCH;
(9) information about a PDSCH;
(10) MSG 2 information of a PRACH;
(11) MSG 4 information of the PRACH; or
(12) MSG B information of the PRACH.

Optionally, before the network side device sends the first information to the terminal, the network side device may receive the second information from the terminal, where the second information includes information related when the terminal performs data collection or data reporting for AI-based CSI prediction; and
the network side device determines the first information based on the second information.

Optionally, the network side device may send reporting information to the terminal, where the reporting information is used to indicate CSI report configuration information of data collection for AI-based CSI prediction.

It should be noted that the network side device may simultaneously send the reporting information and the first information to the terminal, or may separately send the reporting information and the first information to the terminal.

Optionally, the reporting information may include at least one of the following:
1) a reporting granularity, including CSI or a CSI prediction sample;
2) a time sequence indication, used to indicate whether CSI data is continuously reported;
3) an annotation indication, used to indicate whether a type of CSI data is annotated, where the type of the CSI data includes historical CSI or to-be-predicted/future CSI;
4) CSI report configuration information used for channel feedback; or
5) a second data collection characteristic, used to indicate the terminal to retain or store CSI data fed back based on the CSI report configuration information used for channel feedback.

Optionally, the network side device may receive a data reporting request from the terminal, where the data reporting request is used to represent that the terminal has collected the CSI data;
the network side device sends a data reporting instruction to the terminal based on the data reporting request; and
the network side device receives the CSI data or a CSI prediction sample corresponding to the CSI data from the terminal.

Optionally, the network side device may send a data reporting instruction to the terminal based on the first information; and
the network side device receives the CSI data or a CSI prediction sample corresponding to the CSI data from the terminal.

Optionally, the CSI prediction sample may include at least one of the following:
1) at least one piece of historical CSI; or
2) at least one piece of to-be-predicted/future CSI.

FIG. 8 is a first signaling interaction diagram of a data collection method for AI-based CSI prediction according to an embodiment of this application. As shown in FIG. 8, the method includes step 801 and step 802.

Step 801: A network side device sends first information to a terminal.

Step 802: The terminal performs CSI data collection based on first information, to obtain CSI data, where the CSI data is used for AI model training of AI-based CSI prediction;
where the first information includes at least one of the following:
1) AI model identifier information, used to indicate an AI model corresponding to the CSI data.
2) applicable condition information, used to indicate a condition or a scenario for data collection.
3) data collection start condition information, used to indicate a start condition of data collection.
4) data collection continuity condition information, used to indicate a continuity condition of data collection. 32
5) data collection termination condition information, used to indicate a termination condition of data collection.
6) data collection-related CSI-RS configuration information, used to indicate CSI-RS configuration information of data collection for AI-based CSI prediction.

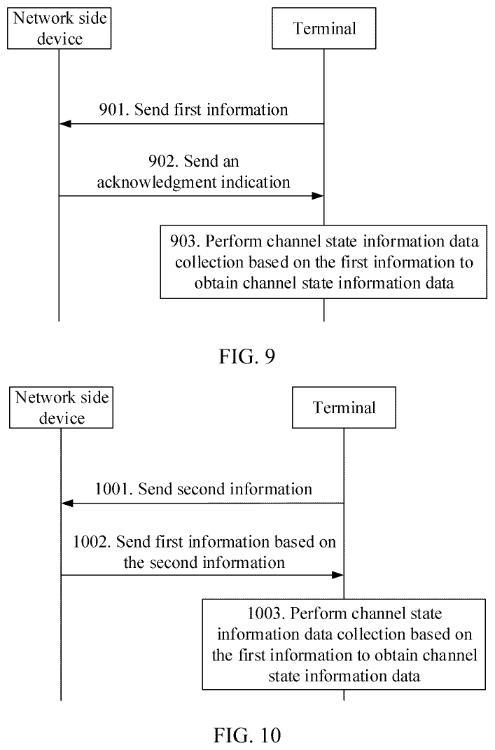

FIG. 9 is a second signaling interaction diagram of a data collection method for AI-based CSI prediction according to an embodiment of this application. As shown in FIG. 9, the method includes step 901 to step 903.

Step 901: A terminal sends first information to a network side device.

Step 902: The terminal receives an acknowledgment indication from the network side

device, where the acknowledgment indication is used to indicate the terminal to perform CSI data collection based on the first information.

Step 903: The terminal performs CSI data collection based on the first information, to obtain CSI data, where the CSI data is used for AI model training of AI-based CSI prediction;
where the first information includes at least one of the following:
1) AI model identifier information, used to indicate an AI model corresponding to the CSI data.
2) applicable condition information, used to indicate a condition or a scenario for data collection.
3) data collection start condition information, used to indicate a start condition of data collection.
4) data collection continuity condition information, used to indicate a continuity condition of data collection.
5) data collection termination condition information, used to indicate a termination condition of data collection.
6) data collection-related CSI-RS configuration information, used to indicate CSI-RS configuration information of data collection for AI-based CSI prediction.

FIG. 10 is a third signaling interaction diagram of a data collection method for AI-based CSI prediction according to an embodiment of this application. As shown in FIG. 10, the method includes step 1001 to step 1003.

Step 1001: A terminal sends second information to a network side device, where the second information includes information related when the terminal performs data collection or data reporting for AI-based CSI prediction.

Step 1002: The network side device sends first information to the terminal based on the second information, where the first information is related to the second information.

Step 1003: The terminal performs CSI data collection based on the first information, to obtain CSI data, where the CSI data is used for AI model training of AI-based CSI prediction;
where the first information includes at least one of the following:
1) AI model identifier information, used to indicate an AI model corresponding to the CSI data.
2) applicable condition information, used to indicate a condition or a scenario for data collection.
3) data collection start condition information, used to indicate a start condition of data collection.
4) data collection continuity condition information, used to indicate a continuity condition of data collection.
5) data collection termination condition information, used to indicate a termination condition of data collection.
6) data collection-related CSI-RS configuration information, used to indicate CSI-RS configuration information of data collection for AI-based CSI prediction.

The following uses an example to describe a data collection method for AI-based CSI prediction according to an embodiment of this application.
I. Main procedure of data collection for CSI prediction initiated by a network side device

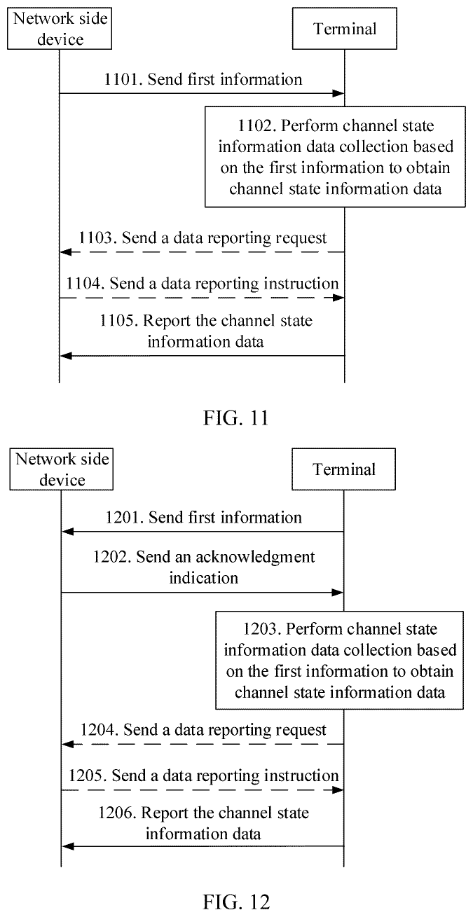

FIG. 11 is a fourth signaling interaction diagram of a data collection method for AI-based CSI prediction according to an embodiment of this application. As shown in FIG. 11, the method includes step 1101 to step 1105.

Step 1101: A network side device sends first information to a terminal.

Step 1102: The terminal performs CSI data collection based on the first information to obtain CSI data.

Step 1103: The terminal sends a data reporting request to the network side device.

Step 1104: The network side device sends a data reporting instruction based on the data reporting request.

Step 1105: The terminal reports the CSI data to the network side device.

It should be noted that step 1103 and step 1104 are optional steps.
II. Main procedure of data collection for CSI prediction initiated by a terminal side
Solution 1. FIG. 12 is a fifth signaling interaction diagram of a data collection method for AI-based CSI prediction according to an embodiment of this application. As shown in FIG. 12, the method includes step 1201 to step 1206.

Step 1201: A terminal sends first information to a network side device.

Step 1202: The network side device sends an acknowledgment indication to the terminal.

Step 1203: The terminal performs CSI data collection based on the first information to obtain CSI data.

Step 1204: The terminal sends a data reporting request to the network side device.

Step 1205: The network side device sends a data reporting instruction based on the data reporting request.

Step 1206: The terminal reports the CSI data to the network side device.

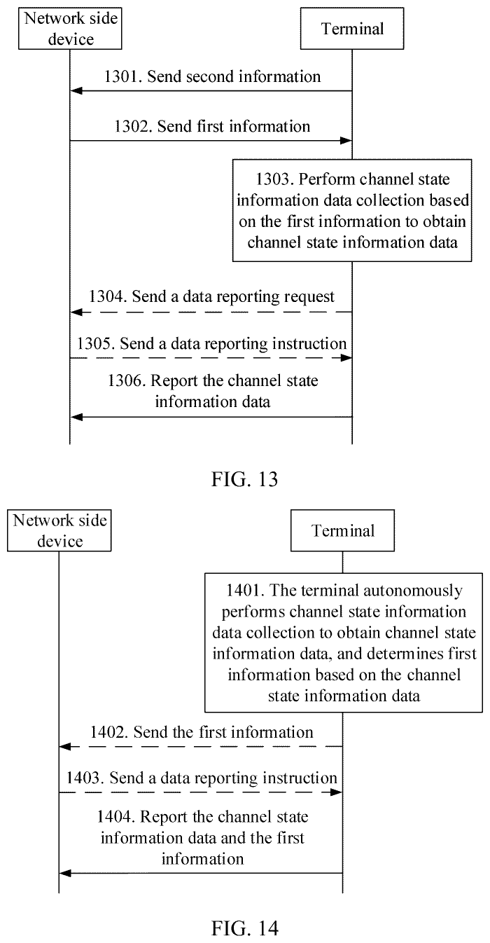

It should be noted that step 1204 and step 1205 are optional steps.
Solution 2. FIG. 13 is a sixth signaling interaction diagram of a data collection method for AI-based CSI prediction according to an embodiment of this application. As shown in FIG. 13, the method includes step 1301 to step 1306.

Step 1301: A terminal sends second information to a network side device.

Step 1302: The network side device sends first information to the terminal.

Step 1303: The terminal performs CSI data collection based on the first information to obtain CSI data.

Step 1304: The terminal sends a data reporting request to the network side device.

Step 1305: The network side device sends a data reporting instruction based on the data reporting request.

Step 1306: The terminal reports the CSI data to the network side device.

It should be noted that step 1304 and step 1305 are optional steps.
III. Main procedure of active collection and reporting on the terminal side

FIG. 14 is a seventh signaling interaction diagram of a data collection method for AI-based CSI prediction according to an embodiment of this application. As shown in FIG. 14, the method includes step 1401 to step 1404.

Step 1401: A terminal autonomously performs CSI data collection to obtain CSI data, and determines first information based on the CSI data.

Step 1402: The terminal sends the first information to a network side device.

Step 1403: The network side device sends a data reporting instruction based on the first information.

Step 1404: The terminal reports the CSI data and the first information to the network side device.

Specifically, the first information reported by the terminal to the network side device in step 1404 corresponds to the reported CSI data, and is mainly used to describe a data collection configuration corresponding to the reported CSI data.

It should be noted that step 1402 and step 1403 are optional steps.

In an embodiment of this application, a data collection method for AI-based CSI prediction is proposed, which is used to support data collection and collection data reporting for AI-based CSI prediction.

According to the data collection method for AI-based CSI prediction provided in this embodiment of this application, an execution body may be a data collection apparatus for AI-based CSI prediction. In this embodiment of this application, that the data collection apparatus for AI-based CSI prediction performs a data collection method for AI-based CSI prediction is used as an example to describe the data collection apparatus for AI-based CSI prediction provided in this embodiment of this application.

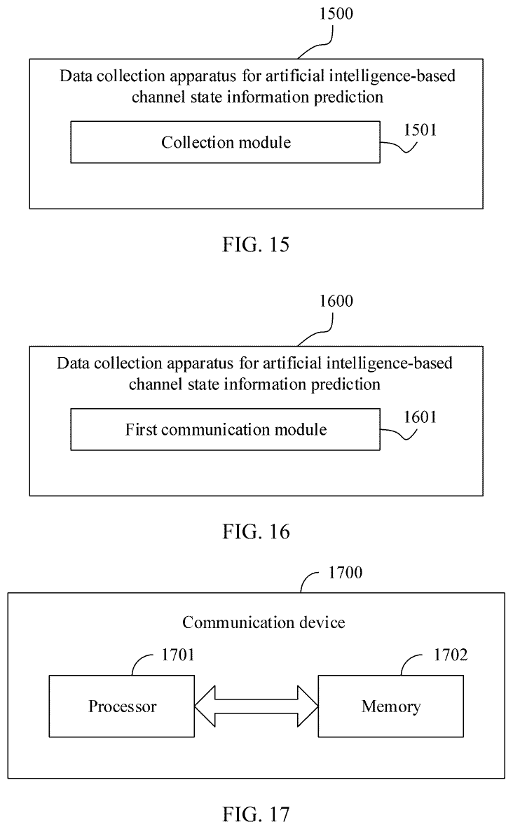

FIG. 15 is a first schematic diagram of a structure of a data collection apparatus for AI-based CSI prediction according to an embodiment of this application. As shown in FIG. 15, the data collection apparatus for AI-based CSI prediction 1500 is applied to a terminal and includes:
a collection module 1501, configured to perform at least one of the following:
(1) autonomously performing CSI data collection to obtain CSI data; or
(2) performing CSI data collection based on first information, to obtain CSI data, where the CSI data is used for AI model training of AI-based CSI prediction;
where the first information includes at least one of the following:
1) AI model identifier information, used to indicate an AI model corresponding to the CSI data.
2) applicable condition information, used to indicate a condition or a scenario for data collection.
3) data collection start condition information, used to indicate a start condition of data collection.
4) data collection continuity condition information, used to indicate a continuity condition of data collection.
5) data collection termination condition information, used to indicate a termination condition of data collection.
6) data collection-related CSI-RS configuration information, used to indicate CSI-RS configuration information of data collection for AI-based CSI prediction.

In the data collection apparatus for AI-based CSI prediction provided in this embodiment of this application, compared with that an existing CSI-RS configuration cannot support data collection for AI-based CSI prediction, in embodiments of this application, the collection module can perform CSI data collection autonomously or based on first information to obtain CSI data, and further may perform AI model training of AI-based CSI prediction by using the CSI data. That is, the data collection method for AI-based CSI prediction provided in this application can support data collection for AI-based CSI prediction.

Optionally, the AI model identifier information may include at least one of the following:
1) an AI function ID;
2) an AI model ID;
3) an AI model physical ID;
4) an AI model logical ID;
5) an AI model global ID; or
6) an AI model local ID.

Optionally, the applicable condition information may include at least one of the following:
(1) a channel condition;
(2) a scenario condition;
(3) a moving speed condition; or
(4) an accessed cell range or cell ID list condition.

Optionally, the data collection start condition information may include at least one of the following:
1) data collection start time;
2) a data collection start location; or
3) applicable condition information.

Optionally, the data collection continuity condition information may include at least one of the following:
(1) a condition of a quantity of collected CSI or samples;
(2) a collection duration condition; or
(3) applicable condition information.

Optionally, the data collection termination condition information may include at least one of the following:
1) end time;
2) collection time exceeds a first threshold;
3) a quantity of collected CSI or CSI samples exceeds a second threshold;
4) meeting or not meeting applicable condition information; or
5) a quantity of cell handover times exceeds a third threshold.

Optionally, the data collection-related CSI-RS configuration information may include at least one of the following:
(1) CSI-RS configuration information used for collecting at least one piece of historical CSI and at least one piece of to-be-predicted/future CSI;
(2) CSI-RS configuration information used for collecting at least one piece of historical CSI and at least one piece of to-be-predicted/future CSI, and period information;
(3) CSI-RS configuration information used for channel measurement, and CSI-RS configuration information used for collecting at least one piece of to-be-predicted/future CSI; or
(4) CSI-RS configuration information used for channel measurement and a first data collection characteristic, where the first data collection characteristic is used to indicate the terminal to retain or store CSI data measured based on the CSI-RS configuration information used for channel measurement.

Optionally, the data collection apparatus for AI-based CSI prediction 1500 further includes:
a second communication module, configured to receive the first information from a network side device.

Optionally, the second communication module is specifically configured to receive the first information transmitted by the network side device based on at least one of the following information or signaling:
(1) a MAC CE;
(2) an RRC message;
(3) a NAS message;
(4) a management and orchestration message;
(5) user plane data;
(6) DCI information;
(7) a SIB;
(8) layer 1 signaling of a PDCCH;
(9) information about a PDSCH;
(10) MSG 2 information of a PRACH;
(11) MSG 4 information of the PRACH; or
(12) MSG B information of the PRACH.

Optionally, the second communication module is further configured to:
before the terminal performs CSI data collection based on the first information, to obtain the CSI data, send the first information to the network side device; and
receive an acknowledgment indication from the network side device, where the acknowledgment indication is used to indicate the terminal to perform CSI data collection based on the first information.

Optionally, the second communication module is further configured to:
before the terminal performs CSI data collection based on the first information, to obtain the CSI data, send second information to the network side device, where the second information includes information related when the terminal performs data collection or data reporting for AI-based CSI prediction; and
receive the first information from the network side device, where the first information is related to the second information.

Optionally, the second communication module is further configured to:
receive reporting information from the network side device, where the reporting information is used to indicate CSI report configuration information of data collection for AI-based CSI prediction.

Optionally, the reporting information may include at least one of the following:
1) a reporting granularity, including CSI or a CSI prediction sample;
2) a time sequence indication, used to indicate whether CSI data is continuously reported;
3) an annotation indication, used to indicate whether a type of CSI data is annotated, where the type of the CSI data includes historical CSI or to-be-predicted/future CSI;
4) CSI report configuration information used for channel feedback; or
5) a second data collection characteristic, used to indicate the terminal to retain or store CSI data fed back based on the CSI report configuration information used for channel feedback.

Optionally, the second communication module is further configured to:
send a data reporting request to the network side device, where the data reporting request is used to represent that the terminal has collected the CSI data;
receive a data reporting instruction from the network side device; and
send the CSI data or a CSI prediction sample corresponding to the CSI data to the network side device based on the data reporting instruction and the reporting information.

Optionally, the second communication module is further configured to:
after CSI data collection is autonomously performed to obtain the CSI data, determine the first information based on the CSI data, and send the first information to the network side device, where the first information is used to indicate that a data collection operation that meets the first information has been completed or request to report CSI data that meets the first information;
receive a data reporting instruction from the network side device; and
send the CSI data or a CSI prediction sample corresponding to the CSI data to the network side device based on the data reporting instruction and the reporting information.

Optionally, the CSI prediction sample may include at least one of the following:
1) at least one piece of historical CSI; or
2) at least one piece of to-be-predicted/future CSI.

Optionally, the data collection apparatus for AI-based CSI prediction 1500 further includes:
a processing module, configured to: in a case that abnormal CSI exists in the CSI data, perform any one of the following processing on the abnormal CSI:
(1) discarding the abnormal CSI, and reporting an indication corresponding to the abnormal CSI;
(2) reporting the abnormal CSI based on a preset format; and
(3) constructing, based on continuous CSI and the abnormal CSI that are in the CSI data, target CSI corresponding to the abnormal CSI, and reporting the target CSI.

FIG. 16 is a second schematic diagram of a structure of a data collection apparatus for AI-based CSI prediction according to an embodiment of this application. As shown in FIG. 16, the data collection apparatus for AI-based CSI prediction 1600 is applied to a network side device and includes:
a first communication module 1601, configured to perform any one of the following:
sending first information to a terminal;
receiving first information from a terminal, and sending an acknowledgment indication to the terminal, where the acknowledgment indication is used to indicate the terminal to perform CSI data collection based on the first information to obtain CSI data, and the CSI data is used for AI model training of AI-based CSI prediction; or
receiving first information from a terminal, where the first information is used to indicate that a data collection operation that meets the first information has been completed or request to report CSI data that meets the first information;
where the first information includes at least one of the following:
1) AI model identifier information, used to indicate an AI model corresponding to the CSI data.
2) applicable condition information, used to indicate a condition or a scenario for data collection.
3) data collection start condition information, used to indicate a start condition of data collection.
4) data collection continuity condition information, used to indicate a continuity

condition of data collection.
5) data collection termination condition information, used to indicate a termination condition of data collection.
6) data collection-related CSI-RS configuration information, used to indicate CSI-RS configuration information of data collection for AI-based CSI prediction.

In the data collection apparatus for AI-based CSI prediction provided in this embodiment of this application, compared with that an existing CSI-RS configuration cannot support data collection for AI-based CSI prediction, in this embodiment of this application, the first communication module may send first information to a terminal; or the first communication module sends an acknowledgment indication to a terminal by receiving first information from the terminal, so as to indicate the terminal to perform CSI data collection based on the first information; or the first communication module receives first information from a terminal, so as to indicate that a data collection operation that meets the first information has been completed or request to report CSI data that meets the first information, and further may perform AI model training of AI-based CSI prediction by using the CSI data. That is, the data collection method for AI-based CSI prediction provided in this application can support data collection for AI-based CSI prediction.

Optionally, the AI model identifier information may include at least one of the following:
1) an AI function ID;
2) an AI model ID;
3) an AI model physical ID;
4) an AI model logical ID;
5) an AI model global ID; or
6) an AI model local ID.

Optionally, the applicable condition information may include at least one of the following:
(1) a channel condition;
(2) a scenario condition;
(3) a moving speed condition; or
(4) an accessed cell range or cell ID list condition.

Optionally, the data collection start condition information may include at least one of the following:
1) data collection start time;
2) a data collection start location; or
3) applicable condition information.

Optionally, the data collection continuity condition information may include at least one of the following:
(1) a condition of a quantity of collected CSI or samples;
(2) a collection duration condition; or
(3) applicable condition information.

Optionally, the data collection termination condition information may include at least one of the following:
1) end time;
2) collection time exceeds a first threshold;
3) a quantity of collected CSI or CSI samples exceeds a second threshold;
4) meeting or not meeting applicable condition information; or
5) a quantity of cell handover times exceeds a third threshold.

Optionally, the data collection-related CSI-RS configuration information may include at least one of the following:
(1) CSI-RS configuration information used for collecting at least one piece of historical CSI and at least one piece of to-be-predicted/future CSI;
(2) CSI-RS configuration information used for collecting at least one piece of historical CSI and at least one piece of to-be-predicted/future CSI, and period information;
(3) CSI-RS configuration information used for channel measurement, and CSI-RS configuration information used for collecting at least one piece of to-be-predicted/future CSI; or
(4) CSI-RS configuration information used for channel measurement and a first data collection characteristic, where the first data collection characteristic is used to indicate the terminal to retain or store CSI data measured based on the CSI-RS configuration information used for channel measurement.

Optionally, the first communication module 1601 is specifically configured to transmit the first information to the terminal based on at least one of the following information or signaling: (1) a MAC CE;
(2) an RRC message;
(3) a NAS message;
(4) a management and orchestration message;
(5) user plane data;
(6) DCI information;
(7) a SIB;
(8) layer 1 signaling of a PDCCH;
(9) information about a PDSCH;
(10) MSG 2 information of a PRACH;
(11) MSG 4 information of the PRACH; or
(12) MSG B information of the PRACH.

Optionally, the first communication module 1601 is further configured to:
receive second information from the terminal, where the second information includes information related when the terminal performs data collection or data reporting for AI-based CSI prediction; and
determine the first information based on the second information.

Optionally, the first communication module 1601 is further configured to:
send reporting information to the terminal, where the reporting information is used to indicate CSI report configuration information of data collection for AI-based CSI prediction.

Optionally, the reporting information may include at least one of the following:
1) a reporting granularity, including CSI or a CSI prediction sample;
2) a time sequence indication, used to indicate whether CSI data is continuously reported;
3) an annotation indication, used to indicate whether a type of CSI data is annotated, where the type of the CSI data includes historical CSI or to-be-predicted/future CSI;
4) CSI report configuration information used for channel feedback; or
5) a second data collection characteristic, used to indicate the terminal to retain or store CSI data fed back based on the CSI report configuration information used for channel feedback.

Optionally, the first communication module 1601 is further configured to:
receive a data reporting request from the terminal, where the data reporting request is used to represent that the terminal has collected the CSI data;
send a data reporting instruction to the terminal based on the data reporting request; and
receive the CSI data or a CSI prediction sample corresponding to the CSI data from the terminal.

Optionally, the first communication module 1601 is further configured to:
send a data reporting instruction to the terminal based on the first information; and
receive the CSI data or a CSI prediction sample corresponding to the CSI data from the terminal.

Optionally, the CSI prediction sample may include at least one of the following:
1) at least one piece of historical CSI; or
2) at least one piece of to-be-predicted/future CSI.

The data collection apparatus for AI-based CSI prediction in this embodiment of this application may be an electronic device, for example, an electronic device with an operating system; or may be a component in an electronic device, for example, an integrated circuit or a chip. The electronic device may be a terminal, or may be another device different from a terminal. For example, the terminal may include but is not limited to the foregoing listed types of the terminal 11. The another device may be a server, a network attached storage (Network Attached Storage, NAS), or the like. This is not specifically limited in this embodiment of this application.

The data collection apparatus for AI-based CSI prediction provided in this embodiment of this application can implement various processes implemented in the method embodiments of FIG. 6 to FIG. 14, and achieve the same technical effects. To avoid repetition, details are not described herein again.

FIG. 17 is a communication device according to an embodiment of this application. As shown in FIG. 17, an embodiment of this application further provides a communication device 1700, including a processor 1701 and a memory 1702. The memory 1702 stores a program or instructions capable of running on the processor 1701. For example, when the communication device 1700 is a terminal, the program or the instructions are executed by the processor 1701 to implement the steps in the foregoing embodiments of the data collection method for AI-based CSI prediction, and the same technical effects can be achieved. When the communication device 1700 is a network side device, the program or the instructions are executed by the processor 1701 to implement the steps in the foregoing embodiments of the data collection method for AI-based CSI prediction, and the same technical effects can be achieved. To avoid repetition, details are not described herein again.

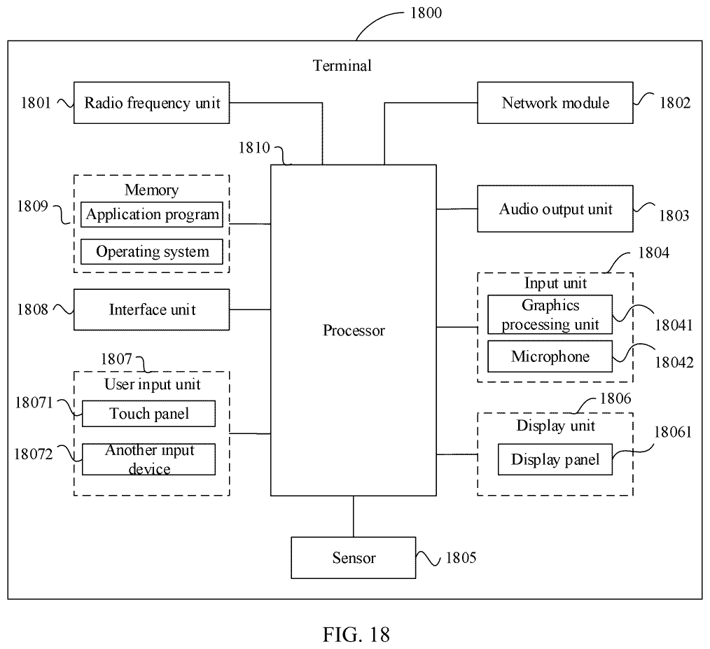

An embodiment of this application further provides a terminal, including a processor and a communication interface. The communication interface is coupled to the processor. The processor is configured to run a program or instructions to implement the steps in the method embodiment shown in FIG. 6. This terminal embodiment is corresponding to the foregoing terminal side method embodiment. Each implementation process and implementation of the foregoing method embodiment may be applied to this terminal embodiment, and the same technical effects can be achieved. Specifically, FIG. 18 is a schematic diagram of a hardware structure of a terminal according to an embodiment of this application.

The terminal 1800 includes but is not limited to at least some of the following components: a radio frequency unit 1801, a network module 1802, an audio output unit 1803, an input unit 1804, a sensor 1805, a display unit 1806, a user input unit 1807, an interface unit 1808, a memory 1809, a processor 1810, and the like.

A person skilled in the art may understand that the terminal 1800 may further include a power supply (for example, a battery) that supplies power to each component. The power supply may be logically connected to the processor 1810 by using a power management system, to implement functions such as charging management, discharging management, and power consumption management through the power management system. The structure of the terminal shown in FIG. 18 does not constitute a limitation on the terminal. The terminal may include more or fewer components than those shown in the figure, or combine some components, or have different component arrangements. Details are not described herein again.

It should be understood that in this embodiment of this application, the input unit 1804 can include a graphics processing unit (Graphics Processing Unit, GPU) 18041 and a microphone 18042. The graphics processing unit 18041 processes image data of a still picture or a video obtained by an image capture apparatus (for example, a camera) in a video capture mode or an image capture mode. The display unit 1806 can include a display panel 18061, and the display panel 18061 can be configured in a form of a liquid crystal display, an organic light-emitting diode, or the like. The user input unit 1807 includes at least one of a touch panel 18071 or another input device 18072. The touch panel 18071 is also referred to as a touchscreen. The touch panel 18071 can include two parts: a touch detection apparatus and a touch controller. The another input device 18072 may include but is not limited to a physical keyboard, a function key (such as a volume control key or an on/off key), a trackball, a mouse, and a joystick. Details are not described herein again.

In this embodiment of this application, after receiving downlink data from a network side device, the radio frequency unit 1801 may transmit the downlink data to the processor 1810 for processing. In addition, the radio frequency unit 1801 may send uplink data to the network side device. Generally, the radio frequency unit 1801 includes but is not limited to an antenna, an amplifier, a transceiver, a coupler, a low-noise amplifier, a duplexer, and the like.

The memory 1809 may be configured to store a software program or instructions and various types of data. The memory 1809 may mainly include a first storage area for storing a program or instructions and a second storage area for storing data. The first storage area may store an operating system, an application program or instructions required by at least one function (for example, a sound play function or an image play function), and the like. In addition, the memory 1809 may include a volatile memory or a nonvolatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 1809 in this embodiment of this application includes but is not limited to these memories and any other suitable type of memory.

The processor 1810 may include one or more processing units. Optionally, the processor 1810 integrates an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 1810.

It may be understood that for implementation processes of the implementations mentioned in this embodiment, reference may be made to related descriptions of the data collection method for AI-based CSI prediction in the method embodiment, and same or corresponding technical effects are achieved. To avoid repetition, details are not described herein again.

An embodiment of this application further provides a network side device, including a processor and a communication interface. The communication interface is coupled to the processor. The processor is configured to run a program or instructions to implement the steps in the method embodiment shown in FIG. 7. This network side device embodiment is corresponding to the foregoing method embodiment for the network side device, and each implementation process and implementation of the foregoing method embodiment can be applied to this network side device embodiment, and the same technical effects can be achieved.

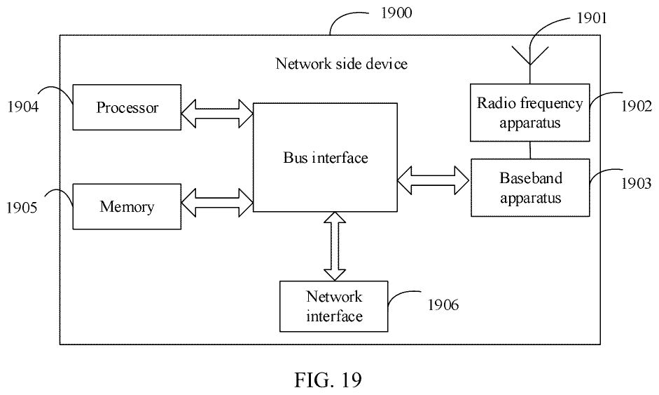

Specifically, an embodiment of this application further provides a network side device. FIG. 19 is a network side device according to an embodiment of this application. As shown in FIG. 19, the network side device 1900 includes an antenna 1901, a radio frequency apparatus 1902, a baseband apparatus 1903, a processor 1904, and a memory 1905. The antenna 1901 is connected to the radio frequency apparatus 1902. In an uplink direction, the radio frequency apparatus 1902 receives information through the antenna 1901, and sends the received information to the baseband apparatus 1903 for processing. In a downlink direction, the baseband apparatus 1903 processes to-be-sent information, and sends processed information to the radio frequency apparatus 1902. After processing the received information, the radio frequency apparatus 1902 sends processed information through the antenna 1901.

The method performed by the network side device in the foregoing embodiment may be implemented in the baseband apparatus 1903. The baseband apparatus 1903 includes a baseband processor.

For example, the baseband apparatus 1903 may include at least one baseband board. A plurality of chips are disposed on the baseband board. As shown in FIG. 19, one of the chips is, for example, the baseband processor, and is connected to the memory 1905 by using a bus interface, to invoke a program in the memory 1905 to perform an operation of a network device shown in the foregoing method embodiment.

The network side device may further include a network interface 1906, and the interface is, for example, a common public radio interface (Common Public Radio Interface, CPRI).

Specifically, the network side device 1900 in this embodiment of this application further includes instructions or a program stored in the memory 1905 and capable of running on the processor 1904. The processor 1904 invokes the instructions or the program in the memory 1905 to perform the method performed by the modules shown in FIG. 16, and the same technical effects are achieved. To avoid repetition, details are not described herein again.

An embodiment of this application further provides a readable storage medium. The readable storage medium stores a program or instructions. The program or the instructions are executed by a processor to implement processes in the foregoing method embodiments of the data collection method for AI-based CSI prediction, and the same technical effects can be achieved. To avoid repetition, details are not described herein again.

The processor is a processor in the terminal described in the foregoing embodiments. The readable storage medium includes a computer-readable storage medium, for example, a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface. The communication interface is coupled to the processor. The processor is configured to run a program or instructions to implement processes in the foregoing embodiments of the data collection method for AI-based CSI prediction on the terminal side or the data collection method for AI-based CSI prediction on the network side, and the same technical effects can be achieved. To avoid repetition, details are not described herein again.

It should be understood that the chip mentioned in this embodiment of this application can also be referred to as a system-level chip, a system chip, a chip system, a system on chip, or the like.

An embodiment of this application further provides a computer program/program product. The computer program/program product is stored in a storage medium. The computer program/program product is executed by at least one processor to implement processes in the foregoing embodiments of the data collection method for AI-based CSI prediction on the terminal side or the data collection method for AI-based CSI prediction on the network side, and the same technical effects can be achieved. To avoid repetition, details are not described herein again. An embodiment of this application further provides a data collection system for AI-based CSI prediction, including a terminal and a network side device, where the terminal may be configured to perform the steps of the foregoing data collection method for AI-based CSI prediction on the terminal side, and the network side device may be configured to perform the steps of the foregoing data collection method for AI-based CSI prediction on the network side.

It should be noted that in this specification, the term “include”, “comprise”, or any of their variants is intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that the scope of the method and apparatus in the implementations of this application is not limited to performing functions in a sequence shown or discussed, and may further include performing functions in a basically simultaneous manner or in a reverse sequence based on related functions. For example, the described method may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a storage medium (such as a ROM, a RAM, a magnetic disk, or an optical disc) and includes several instructions for instructing a terminal or a network side device to perform the methods described in embodiments of this application.

The foregoing describes embodiments of this application with reference to the accompanying drawings. However, this application is not limited to the foregoing specific implementations. The foregoing specific implementations are merely illustrative rather than restrictive. Inspired by this application, a person of ordinary skill in the art may develop many forms of implementations without departing from principles of this application and the protection scope of the claims, and all such implementations fall within the protection scope of this application.

1. A data collection method for artificial intelligence-based (AI-based) channel state information (CSI) prediction, comprising any one of the following:
autonomously performing, by a terminal, CSI data collection to obtain CSI data; or
performing, by a terminal, CSI data collection based on first information, to obtain CSI data, wherein the CSI data is used for AI model training of AI-based CSI prediction;
wherein the first information comprises at least one of the following:
AI model identifier information, used to indicate an AI model corresponding to the CSI data;
applicable condition information, used to indicate a condition or a scenario for data collection;
data collection start condition information, used to indicate a start condition of data collection;
data collection continuity condition information, used to indicate a continuity condition of data collection;
data collection termination condition information, used to indicate a termination condition of data collection; or
data collection-related channel state information reference signal (CSI-RS) configuration information, used to indicate CSI-RS configuration information of data collection for AI-based CSI prediction.

2. The data collection method for AI-based CSI prediction according to claim 1, wherein the AI model identifier information comprises at least one of the following:
an AI function identifier (ID); an AI model ID; an AI model physical ID; an AI model logical ID; an AI model global ID; or an AI model local ID.

3. The data collection method for AI-based CSI prediction according to claim 1, wherein the applicable condition information comprises at least one of the following:
a channel condition; a scenario condition; a moving speed condition; or an accessed cell range or cell ID list condition.

4. The data collection method for AI-based CSI prediction according to claim 1, wherein the data collection start condition information comprises at least one of the following:
data collection start time; a data collection start location; or applicable condition information.

5. The data collection method for AI-based CSI prediction according to claim 1, wherein the data collection continuity condition information comprises at least one of the following:
a condition of a quantity of collected CSI or samples; a collection duration condition; or
applicable condition information.

6. The data collection method for AI-based CSI prediction according to claim 1, wherein the data collection termination condition information comprises at least one of the following:
end time; collection time exceeds a first threshold; a quantity of collected CSI or CSI samples exceeds a second threshold; meeting or not meeting applicable condition information; or a quantity of cell handover times exceeds a third threshold.

7. The data collection method for AI-based CSI prediction according to claim 1, wherein the data collection-related CSI-RS configuration information comprises at least one of the following:
CSI-RS configuration information used for collecting at least one piece of historical CSI and at least one piece of to-be-predicted/future CSI;
CSI-RS configuration information used for collecting at least one piece of historical CSI and at least one piece of to-be-predicted/future CSI, and period information;
CSI-RS configuration information used for channel measurement, and CSI-RS configuration information used for collecting at least one piece of to-be-predicted/future CSI; or
CSI-RS configuration information used for channel measurement and a first data collection characteristic, wherein the first data collection characteristic is used to indicate the terminal to retain or store CSI data measured based on the CSI-RS configuration information used for channel measurement.

8. The data collection method for AI-based CSI prediction according to claim 1, wherein the method further comprises:
receiving, by the terminal, reporting information from a network side device, wherein the reporting information is used to indicate CSI report configuration information of data collection for AI-based CSI prediction.

9. The data collection method for AI-based CSI prediction according to claim 8, wherein the reporting information comprises at least one of the following:
a reporting granularity, comprising CSI or a CSI prediction sample;
a time sequence indication, used to indicate whether CSI data is continuously reported;
an annotation indication, used to indicate whether a type of CSI data is annotated, wherein the type of the CSI data comprises historical CSI or to-be-predicted/future CSI;
CSI report configuration information used for channel feedback; or
a second data collection characteristic, used to indicate the terminal to retain or store CSI data fed back based on the CSI report configuration information used for channel feedback.

10. A data collection method for artificial intelligence-based (AI-based) channel state information (CSI) prediction, comprising any one of the following:
sending, by a network side device, first information to a terminal;
receiving, by a network side device, first information from a terminal, and sending an acknowledgment indication to the terminal, wherein the acknowledgment indication is used to indicate the terminal to perform CSI data collection based on the first information to obtain CSI data, and the CSI data is used for AI model training of AI-based CSI prediction; or
receiving, by a network side device, first information from a terminal, wherein the first information is used to indicate that a data collection operation that meets the first information has been completed or request to report CSI data that meets the first information;
wherein the first information comprises at least one of the following:
AI model identifier information, used to indicate an AI model corresponding to the CSI data;
applicable condition information, used to indicate a condition or a scenario for data collection;
data collection start condition information, used to indicate a start condition of data collection;
data collection continuity condition information, used to indicate a continuity condition of data collection;
data collection termination condition information, used to indicate a termination condition of data collection; or
data collection-related channel state information reference signal (CSI-RS) configuration information, used to indicate CSI-RS configuration information of data collection for AI-based CSI prediction.

11. The data collection method for AI-based CSI prediction according to claim 10, wherein the AI model identifier information comprises at least one of the following:
an AI function identifier (ID); an AI model ID; an AI model physical ID; an AI model logical ID; an AI model global ID; or an AI model local ID.

12. The data collection method for AI-based CSI prediction according to claim 10, wherein the applicable condition information comprises at least one of the following:
a channel condition; a scenario condition; a moving speed condition; or an accessed cell range or cell ID list condition.

13. The data collection method for AI-based CSI prediction according to claim 10, wherein the data collection start condition information comprises at least one of the following:
data collection start time; a data collection start location; or applicable condition information.

14. The data collection method for AI-based CSI prediction according to claim 10, wherein the data collection continuity condition information comprises at least one of the following:
a condition of a quantity of collected CSI or samples; a collection duration condition; or applicable condition information.

15. The data collection method for AI-based CSI prediction according to claim 10, wherein the data collection termination condition information comprises at least one of the following:
end time; collection time exceeds a first threshold; a quantity of collected CSI or CSI samples exceeds a second threshold; meeting or not meeting applicable condition information; or a quantity of cell handover times exceeds a third threshold.

16. The data collection method for AI-based CSI prediction according to claim 10, wherein the data collection-related CSI-RS configuration information comprises at least one of the following:
CSI-RS configuration information used for collecting at least one piece of historical CSI and at least one piece of to-be-predicted/future CSI;
CSI-RS configuration information used for collecting at least one piece of historical CSI and at least one piece of to-be-predicted/future CSI, and period information;
CSI-RS configuration information used for channel measurement, and CSI-RS configuration information used for collecting at least one piece of to-be-predicted/future CSI; or
CSI-RS configuration information used for channel measurement and a first data collection characteristic, wherein the first data collection characteristic is used to indicate the terminal to retain or store CSI data measured based on the CSI-RS configuration information used for channel measurement.

17. The data collection method for AI-based CSI prediction according to claim 10, wherein the method further comprises:
sending, by the network side device, reporting information to the terminal, wherein the reporting information is used to indicate CSI report configuration information of data collection for AI-based CSI prediction.

18. A terminal, comprising a processor and a memory, wherein the memory stores a program or instructions capable of running on the processor, and the program or the instructions are executed by the processor to implement a data collection method for artificial intelligence-based (AI-based) channel state information (CSI) prediction,
wherein the method comprises any one of the following:
autonomously performing, by the terminal, CSI data collection to obtain CSI data; or
performing, by the terminal, CSI data collection based on first information, to obtain CSI data, wherein the CSI data is used for AI model training of AI-based CSI prediction;
wherein the first information comprises at least one of the following:
AI model identifier information, used to indicate an AI model corresponding to the CSI data;
applicable condition information, used to indicate a condition or a scenario for data collection;
data collection start condition information, used to indicate a start condition of data collection;
data collection continuity condition information, used to indicate a continuity condition of data collection;
data collection termination condition information, used to indicate a termination condition of data collection; or
data collection-related channel state information reference signal (CSI-RS) configuration information, used to indicate CSI-RS configuration information of data collection for AI-based CSI prediction.

19. A network side device, comprising a processor and a memory, wherein the memory stores a program or instructions capable of running on the processor, and the program or the instructions are executed by the processor to implement the steps of the data collection method for AI-based CSI prediction according to claim 10.

20. A non-transitory readable storage medium, wherein the readable storage medium stores a program or instructions, and the program or instructions are executed by a processor to implement the steps of the data collection method for AI-based CSI prediction according to claim 1.
